(19) United States
(12) Patent Application Publication
(10) Pub. No.: US 2005/0231460 A1
(43) Pub. Date: Oct. 20, 2005

(54) Electrophoretic display panel

(75) Inventors: Guofu Zhou, Eindhoven (NL); Alexander Victor Henzen, Heerlen (NL); Martin Jacobus Johan Jak, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/518,257

(22) PCT Filed: Jun. 12, 2003
(86) PCT No.: PCT/IB03/02735

§ 371 Date: Dec. 16, 2004

(30) Foreign Application Priority Data
Jun. 25, 2002 (EP) 02077531.8
Aug. 21, 2002 (EP) 02078456.7

(51) Int. Cl. G09G 3/34

(52) U.S. Cl. 345/107

(57) ABSTRACT

An electrophoretic display panel (1) for displaying pictures has a first and a second opposed substrate (8,9), an electrophoretic medium (5) between the substrates (8,9), a plurality of pixels (2) and drive means (100). The electrophoretic medium (5) has charged particles (6) in a fluid. The first and the second substrate (8,9) have for each pixel (2) a first and a second electrode (3,4), for receiving a potential difference. The potential difference determines positions of the charged particles (6). The drive means (100) are able to control the potential difference of each pixel (2). The switching time is the time interval to change, in operation, the position of the charged particles (6) between the first and the second electrode (3,4). For the display panel (1) to be able to have a reproducible switching time the display panel (1) further has heating means (13) for heating the medium (5) to a medium temperature in the range of 30° C. and 70° C.

The invention relates to an electrophoretic display panel for displaying pictures, comprising:
a first and a second opposed substrate,
an electrophoretic medium between the substrates, the electrophoretic medium comprising charged particles in a fluid,
a plurality of pixels, and
drive means,
   the first and the second substrate having for each pixel a first and a second electrode, respectively, for receiving a potential difference determining positions of the charged particles, and
   the drive means being able to control the potential difference of each pixel.

An embodiment of the electrophoretic display panel of the type mentioned in the opening paragraph is described in non-prepublished European Patent application 02075846.2(PHNL 020156).

In the described electrophoretic display panel, a pixel of the plurality of pixels has a first appearance when the charged particles are near the first electrode and a second appearance when the charged particles are near the second electrode, as a consequence of the potential difference. The time interval to change, in operation, the appearance of the pixel between the first and the second appearance is denoted as switching time. The switching time depends on the potential difference and may be in the order of 150 ms. It appeared, however, that the switching time of the same display panel at a same chosen potential difference may also be substantially longer.

It is a drawback of the described display panel that it is difficult to obtain therewith a reproducible switching time.

It is an object of the invention to provide a display panel of the kind mentioned in the opening paragraph which is able to have a reproducible switching time.

The object is thereby achieved that the display panel further comprises heating means for heating the medium to a medium temperature in the range of 30° C. and 70° C.

The invention is based on the insight that the switching time depends on the medium temperature. Therefore, a display panel, which is able to heat the medium to a chosen medium temperature, is able to have a reproducible switching time. Furthermore, it is an advantage that the switching time can be decreased. The dependency of the switching time with respect to the medium temperature has been determined experimentally. Prior to performing the experiments, the effect on the switching time of a relatively high medium temperature, compared to a reference medium temperature of 25° C., could not be predicted. At least two mechanisms play a role, the resultant of which could not be predicted. The first mechanism is related to the viscosity of the medium, the second mechanism is related to leakage currents through the medium. If, compared to the reference medium temperature, the medium temperature is increased, the viscosity of the fluid is decreased. Therefore, the mobility of the charged particles is increased and as a result of this the switching time is decreased. However, if the medium temperature is increased, also the mobility of ions in the fluid is increased. Therefore, the leakage currents between the electrodes are increased, decreasing the potential difference across the medium. As a result of this the switching time is increased.

It appeared that at the medium temperature in the range between 30° C. and 70° C., the switching time is relatively short compared to the switching time at the reference medium temperature. There is an upper value of the medium temperature range in which the switching time benefits from an increased medium temperature. Therefore, at the medium temperature in the range between 30° C. and 70° C., the display panel has a shortened and reproducible switching time.

In an embodiment the heating means comprise:
a heating element,
a temperature probe, able to measure the medium temperature, and
   a temperature controller, able to control the heating element, in dependence of the measured medium temperature. The heating element is for instance able to generate infra red radiation for heating the medium. Another type of heating element, able to transform electrical energy into heat for heating the medium, may for instance be present in the medium or be in contact with the medium. The temperature probe is for instance a Si-based device or a thermocouple. The probe is able to measure the medium temperature relatively fast if the probe is present in the medium or in contact with the medium, compared to the probe being distant from the medium. The temperature controller is able to control the heating power of the heating element If the heating element is able to heat the medium via the first substrate, the heating element need not be in direct contact with the medium. The heating element may for instance be in contact with a surface of the first substrate facing, or facing away, from the medium. Examples of the heating element are a Peltier element, a heating foil, a heating coil, a ventilator, a fan and a lamp. The time to heat the medium from a first medium temperature to a second medium temperature is denoted as heating time. In an embodiment, allowing for a relatively short heating time, the first substrate has a relatively large heat conductivity, e.g. it consists of a metal in stead of a plastic. In another embodiment, able to have a relatively short heating time, the first substrate has a heat conducting layer, covering at least a portion of a surface of the first substrate and being in contact with the heating element.

Within the scope of the invention many variations are possible, for instance the display panel comprising multiple heating elements and multiple temperature probes.

These and other aspects of the invention will be further elucidated and described with reference to the drawings, in which:

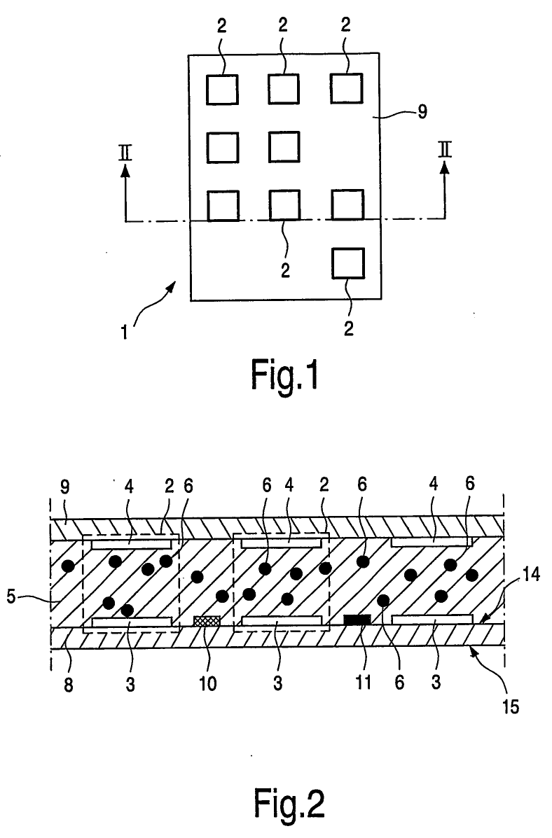

FIG. 1 shows diagrammatically a front view of the display panel,

FIG. 2 shows diagrammatically an embodiment of a cross-sectional view along II-II in FIG. 1,

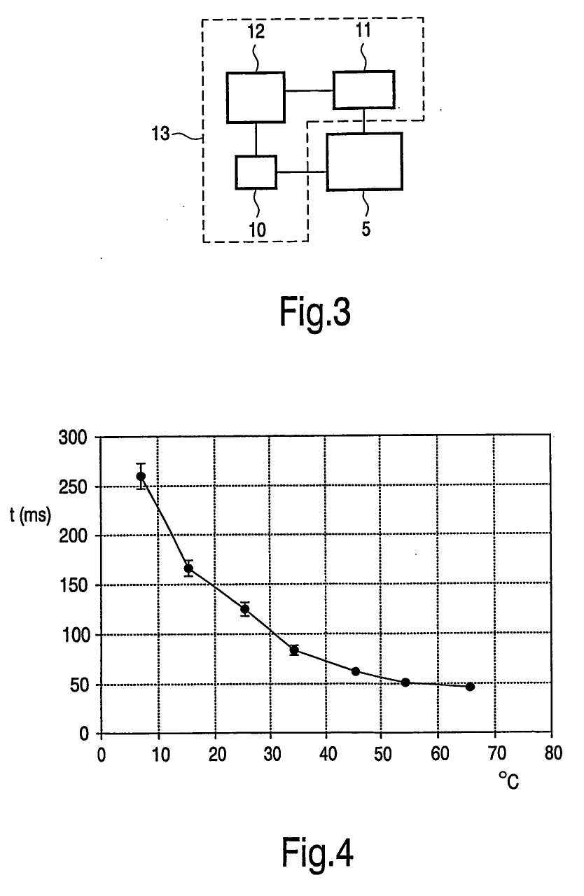

FIG. 3 shows diagrammatically the heating means and the medium,

FIG. 4 shows in a graphical form the relation between the medium temperature and the switching time,

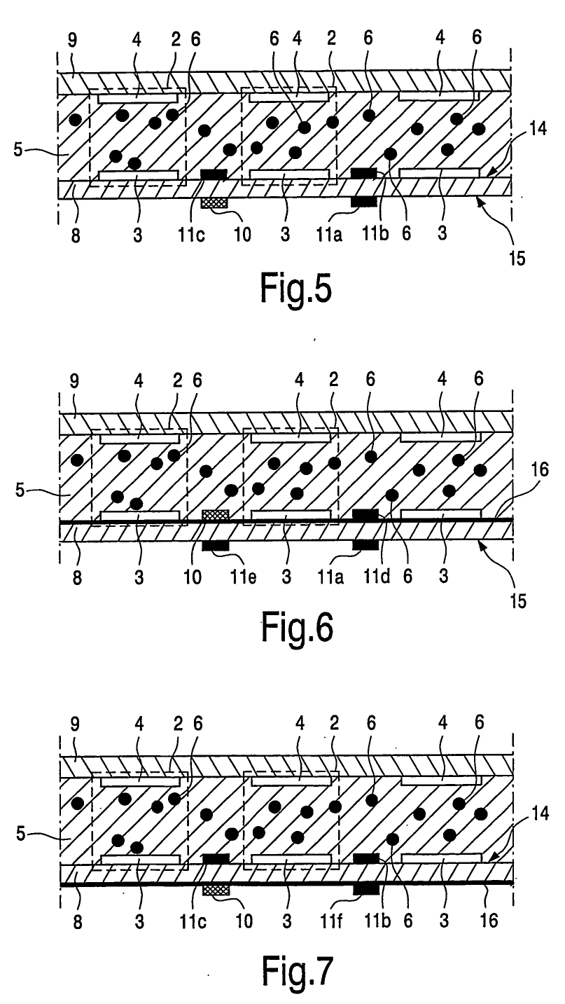

FIG. 5 shows diagrammatically a cross-sectional view along II-II in FIG. 1 of a second embodiment,

FIG. 6 shows diagrammatically a cross-sectional view along II-II in FIG. 1 of a third embodiment,

FIG. 7 shows diagrammatically a cross-sectional view along II-II in FIG. 1 of a fourth embodiment, and

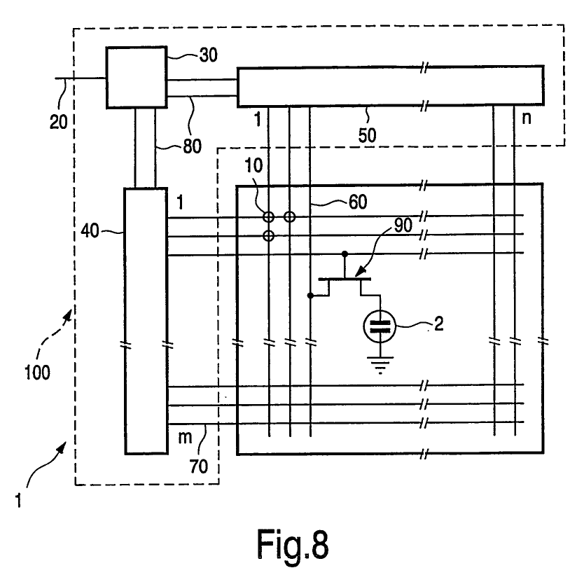

FIG. 8 shows diagrammatically an equivalent circuit diagram of a portion of the display panel.

The Figures are schematic and not drawn to scale and in all the Figures corresponding parts are referenced to by the same reference numerals.

FIG. 1 shows the display panel 1 having a plurality of pixels 2. The pixels 2 are for instance arranged along substantially straight lines in a two-dimensional structure.

FIG. 2 shows the display panel 1 having a first substrate 8 and a second opposed substrate 9. An electrophoretic medium 5 is present between the substrates 8,9. The electrophoretic medium 5 consists for instance of negatively charged black particles 6 in a white fluid. Such electrophoretic medium can be obtained from E Ink Corporation. The first substrate 8 has for each pixel 2 a first electrode 3, and the second substrate 9 has for each pixel 2 a second electrode 4. The electrodes 3,4 are able to receive a potential difference determining positions of the charged particles 6. When the charged particles 6 are positioned near the first electrode 3, the pixel 2 has a first appearance, i.e. white, due to a potential difference of 15 Volts when e.g. a potential of 15 Volts is applied at the first electrode 3 and a potential of 0 Volts is applied at the second electrode 4. When the charged particles 6 are positioned near the second electrode 4, due to an opposite potential difference of −15 Volts, the pixel 2 has a second appearance, i.e. black.

FIG. 3 shows the heating means 13, having a heating element 10, a temperature probe 11, and a temperature controller 12. The temperature probe 11 is able to measure the medium temperature and the temperature controller 12 is able to control the heating element 10, in dependence of the measured medium temperature. The heating element 10 may be in contact with the medium 5 and be present at the surface 14 of the first substrate 8 facing the medium 5, see FIG. 2. The temperature probe 11 may be in contact with the medium 5 and be present at the surface 14 of the first substrate 8 facing the medium 5, see FIG. 2.

FIG. 4 shows experimental results of the relation between the medium temperature and the switching time at a potential difference of −15 Volts between the first and the second electrode 3,4. The medium comprises high boiling point fluids. As an example, for the medium temperature in the range of 7° C. and 25° C. the switching time varies more than a factor 2. Therefore, a display panel having heating means 13, which are able to heat the medium to a reproducible medium temperature, e.g. a medium temperature of 25° C., is able to have a reproducible switching time. Furthermore, the switching time decreases with increasing medium temperature. The switching time of 47 ms at a medium temperature of 65° C. is much lower than the switching time of 125 ms at a medium temperature of 25° C.

FIG. 5 shows the heating element 10, able to heat the medium 5 via the first substrate 3. The first substrate 3 consists for instance of a metal foil, having a relatively large heat conductivity. Therefore, the heating element 10 need not be in direct contact with the medium 5. The heating element 10 is for instance in contact with the surface 15 of the first substrate 3 facing away from the medium 5. The temperature probe 11 may have one of several positions: in a first position the temperature probe 11a is present at the surface 15 of the first substrate 3 facing away from the medium 5, in a second position the temperature probe 11b is in contact with the medium 5 and present at the surface 14 of the first substrate 3 facing the medium 5, and in a third position the temperature probe 11c is present at the same surface as temperature probe 11b opposite the heating element 10.

FIG. 6 shows the heating element 10, able to heat the medium 5 via the first substrate 3, and the first substrate 3 has a heat conducting layer 16, which covers the surface 14 of the first substrate 3 facing the medium 5 and is in contact with the heating element 10. The heat conducting layer 16 consists for instance of a thin metal layer of Aluminum, having a thickness of e.g. 10 micrometer, having a relatively large heat conductivity. Furthermore, to have the first electrodes 3 electrically isolated from each other, the heat conducting layer 16 is electrically isolating or an electrically isolating layer is present between the first electrodes 3 and the heat conducting layer 16. However, if the first electrodes 3 may have equal potentials, the heat conducting layer 16 need not be electrically isolated from the first electrodes 3. The temperature probe 11 may have one of several positions: in a first position the temperature probe 11 a is present at the surface 15 of the first substrate 3 facing away from the medium 5, in a second position the temperature probe 11d is in contact with the medium 5 and present at the surface of the heat conducting layer 16 facing the medium 5, and in a third position the temperature probe 11e is present at the surface 15 of the first substrate 3 facing away from the medium 5 opposite the heating element 10.

FIG. 7 shows the heat conducting layer 16 covering the surface 15 of the first substrate 3 facing away from the medium 5 being in contact with the heating element 10. The temperature probe 11 may have one of several positions: in a first position the temperature probe 11b is in contact with the medium 5 and present at the surface 14 of the first substrate 3 facing the medium 5, in a second position the temperature probe 11c is present at the same surface as temperature probe 11b and opposite the heating element 10, and in a third position the temperature probe 11f is present at the surface of the heat conducting layer 16 facing away from the medium.

FIG. 8 shows diagrammatically a portion of the display panel 1 to which the invention is applicable. This display panel comprises drive means 100, being able to control the potential difference of each pixel 2, and a matrix of pixels 2 at the area of crossings of row or selection electrodes 70 and column or data electrodes 60. The row electrodes 70 numbered from 1 to m in FIG. 8 are consecutively selected by means of a row driver 40, while the column electrodes 60 numbered from 1 to n in FIG. 8 are provided with data via a data register 50. If necessary, data to be displayed 20 is first processed in a processor 30. Mutual synchronization between the row driver 40 and the data register 50 takes place via drive lines 80 connected to the processor 30. The drive means 100 comprise, for example, the row driver 40, the row electrodes 70, the data register 50, the column electrodes 60, the drive lines 80 and the processor 30.

Drive signals from the row driver 40 and the data register 50 select a pixel 2, referred to as passive drive. A column electrode 60 receives such a potential with respect to a row electrode 70 that the pixel 2 obtains for instance the first or the second appearance. Drive signals from the row driver 40 select the pixels 2 via thin-film transistors, denoted as TFTs, 90 whose gate electrodes are electrically connected to the row electrodes 70 and whose source electrodes are electrically connected to the column electrodes 60, referred to as active drive. The signal present at the column electrode 60 is transferred via the TFT 90 to the pixel 2. In the example of FIG. 8, such a TFT 90 is shown diagrammatically for only one pixel 2.

It will be apparent that within the scope of the invention many variations are possible for a person skilled in the art.

The scope of the invention is not limited to the exemplary embodiments described herein. The invention is embodied in every novel feature and every combination of features.

1. An electrophoretic display panel for displaying pictures, comprising:
a first and a second opposed substrate,
an electrophoretic medium between the substrates, the electrophoretic medium comprising charged particles in a fluid,
a plurality of pixels, and
drive means,
the first and the second substrate having for each pixel a first and a second electrode, respectively, for receiving a potential difference determining positions of the charged particles, and
the drive means being able to control the potential difference of each pixel, characterized in that
the display panel further comprises heating means for heating the medium to a medium temperature in the range of 30° C. and 70° C.

2. A display panel as claimed in claim 1 characterized in that the heating means comprise:
a heating element,
a temperature probe, able to measure the medium temperature, and
a temperature controller, able to control the heating element, in dependence of the measured medium temperature.

3. A display panel as claimed in claim 2 characterized in that the heating element is able to heat the medium via the first substrate.

4. A display panel as claimed in claim 3 characterized in that the first substrate has a heat conducting layer, covering at least a portion of a surface of the first substrate and being in contact with the heating element.
